(19) United States
(12) Patent Application Publication
(10) Pub. No.: US 2026/0108946 A1
(43) Pub. Date: Apr. 23, 2026

(54) LOW-TEMPERATURE CASE HARDENING OF ADDITIVE MANUFACTURED ARTICLES AND MATERIALS AND TARGETED APPLICATION OF SURFACE MODIFICATION

(71) Applicant: Swagelok Company, Solon, OH (US)

(72) Inventors: Cyprian Adair William Illing, Cleveland Heights, OH (US); Robert Bianco, Columbia Station, OH (US); Michael D. Bestic, Sagamore Hills, OH (US); Christina Semkow, University Heights, OH (US); Peter C. Williams, Cleveland Heights, OH (US); Todd Johns, Solon, OH (US); Ronald S. Edmonson, Munroe Falls, OH (US)

(21) Appl. No.: 19/367,866

(22) Filed: Oct. 24, 2025

Related U.S. Application Data
(63) Continuation of application No. 17/470,287, filed on Sep. 9, 2021.
(60) Provisional application No. 63/076,421, filed on Sep. 10, 2020.

(51) Int. Cl. B22F 10/50; B33Y 40/00; B33Y 80/00; C09D 5/08; C23C 8/22

(52) U.S. Cl. CPC B22F 10/50; C09D 5/086; C23C 8/22; B33Y 40/00; B33Y 80/00

(57) ABSTRACT

A treated additive manufactured article is disclosed. The article comprises a shaped metal alloy having a treated surface layer and a core. At least one of the average hardness of the treated surface layer is greater than the average hardness of the core, and the average corrosion resistance of the treated surface layer is greater than the average corrosion resistance of the core.

### CROSS REFERENCE TO RELATED APPLICATIONS

This application claims is a continuation application of U.S. Ser. No. 17/470,287, filed Sep. 9, 2021, which claims priority to U.S. Provisional Patent Application No. 63/076,421 filed on Sep. 10, 2020, the entire contents of which is herein incorporated by reference.

### FIELD OF THE DISCLOSURE

This disclosure relates to materials and methods involved in additive manufacturing. Specifically, this disclosure relates to processes and methods that increase the hardness and/or corrosion resistance of at least a portion of the surface of articles shaped from metals using additive manufacturing techniques.

### Additive Manufacturing

“Additive manufacturing” (AM, and also referred to as 3D-printing) differs from more conventional manufacturing processes in that it forms 3D objects by adding layer-upon-layer of materials, rather than machining or molding a bulk material or forming via mold. A wide range of materials may be used in AM depending on the specific techniques employed. Plastics and ceramics, for example, may be 3D-printed or “jetted.” Certain polymers may be formed via extrusion or laser sintering. Metal layers or sheets may be laminated together to create a 3D shape. Powdered metals may be fused together by AM to create additive parts. The present disclosure primarily concerns the latter, i.e., metallic materials formed from AM.

Metallic AM generally begins with fusing particles of a powdered metal to create individual layers of the target structure. Fusing techniques vary. They include laser or electron beam powder bed fusion (L-PBF or EB-PBF, respectively) techniques, and a laser deposition technique called direct energy deposition (DED). Metal fused deposition modeling (FDM) uses filaments infused with metal powders and binder to print 3D “green” bodies that are subsequently sintered to densify the powders. Other techniques often applied to AM articles after 3D-printing include hot isostatic pressing (HIP), primarily for densification and reduction of porosity.

An exemplary laser powder bed fusion process 100 appears in FIG. 1. As shown in FIG. 1, metal powder 110a is provided via a powder delivery system 120. A piston 130 pushes the powder 110a upward. A roller 140 moves the powder 110a laterally toward the fabrication piston 150. Once the powder enters the fabrication powder bed, the powder 110b rests on the fabrication piston 150. Then light 160 from laser 170 is applied to fuse powder particles together. A scanner system 180 moves the light beam 160 such that it traces a shape of the object 190 being fabricated in the powder 110b. Generally, one layer of the object 190 is traced at a time. The fabrication piston 150 continuously or stepwise lowers the object 190 so that completed layers can be moved out of the way of the laser and so new layers can be fabricated.

In addition to the above, AM may include “subtractive manufacturing” (SM). SM is a machining process in which solid piece of raw material is carved into a desired 3D geometrical shape and size by using a controlled material-removal process. This process relies heavily upon the use of machine tools in addition to power and hand tools. It may also include laser or other cutting tools. To the extent that any of these processes cause plastic deformation of the surface of the article, they may introduce layers of deformation (e.g., Beilby layers). As described herein and in the references incorporated herein, the techniques of the present disclosure can harden materials both with or without the existence of such layers of deformation.

Additive manufacturing allows for the design of complex flow paths and unique geometries not possible using other manufacturing methods. However, this increased design freedom comes at a cost. For example, residual porosity in AM parts, resulting from incomplete particle fusion, may undermine mechanical strength and degrade corrosion resistance. Although these properties may be improved through post-processing heat treatments (e.g., HIP), the heat treatments also come at a cost. They are typically run at high temperatures and pressures, typically resulting in an annealed material with lower yield strength.

Although the laser powder bed fusion process described above can make ferrules and components for other mechanical applications, hardening the outer surface of those components presents new challenges. Many treatments used to harden materials in conventional manufacturing do not readily apply to AM materials. Therefore, new ways of controlling the properties of the materials used in AM are needed.

### Low Temperature Carburization

Case hardening is a widely used industrial process for enhancing the surface hardness of shaped metal articles. For example, carburizing is a typical commercial process used to harden shaped metal articles. In carburizing, the shaped metal article is contacted with a gaseous carbon compound at elevated temperature whereby carbon atoms liberated by decomposition of the carbon compound diffuse into the article's surface. Hardening occurs through the reaction of these diffused carbon atoms with one or more metals in the workpiece (herein the terms “workpiece” and “article” are used interchangeably) thereby forming distinct chemical compounds, i.e., carbides, followed by precipitation of these carbides as discrete, extremely hard, crystalline particles in the metal forming the workpiece's surface. See Stickels, “Gas Carburizing”, pp 312 to 324, Volume 4, ASM Handbook, © 1991, ASM International.

In the mid 1980's, a technique for case hardening stainless steel was developed in which the shaped metal article is contacted with a carburizing gas at low-temperature, typically below 500° C. (932° F.). At these temperatures, and provided that carburization does not last too long, carbon atoms diffuse into the shaped metal article surfaces, typically to a depth of 20-50 μm without formation of carbide precipitates. Nonetheless, an extraordinarily hard case surface layer can be obtained, which is believed due to the stress placed on the crystal lattice of the metal by the diffused carbon atoms. Moreover, because carbide precipitate presence is minimal, the corrosion resistance of the steel is unimpaired, even improved.

This technique, which is referred to as a “low-temperature carburization,” is described in a number of publications including U.S. Pat. Nos. 5,556,483, 5,593,510, 5,792,282, 6,165,597, 6,547,888, EPO 0787817, Japan 9-14019 (Kokai 9-268364) and Japan 971853 (Kokai 9-71853). The disclosures of these documents are incorporated herein by reference.

### Nitriding and Carbonitriding

In addition to carburization, nitriding and carbonitriding can be used to surface harden various metals. Nitriding works in essentially the same way as carburization except that, rather than using a carbon-containing gas which decomposes to yield carbon atoms for surface hardening, nitriding uses a nitrogen containing gas which decomposes to yield nitrogen atoms for surface hardening.

In the same way as carburization, however, if nitriding is accomplished at higher temperatures and without rapid quenching, hardening occurs through the formation and precipitation of discrete compounds of the diffusing atoms, i.e., nitrides. On the other hand, if nitriding is accomplished at lower temperatures without plasma, hardening occurs without formation of these precipitates through the stress placed on the crystal lattice of the metal by the nitrogen atoms which have diffused into this lattice. As in the case of carburization, stainless steels are not normally nitrided by conventional (high temperature) or plasma nitriding, because the inherent corrosion resistance of the steel is lost when the chromium in the stainless steel reacts with the diffusion nitrogen atoms to cause nitrides to form.

Recent testing of low-temperature nitrocarburization has shown effective surface hardening for austenitic alloys by low-temperature nitrocarburization using solid reagent precursors. See U.S. Pat. No. 10,214,805 and U.S. Provisional Patent Applications Nos. 63/017,259; 63/017,262; 63/017,265; 63/017,271; 63/017,273; 63/017,277, all of which are incorporated herein by reference. The surface hardening process infuses a large amount of carbon and nitrogen into the surface of the shaped metal article. The interstitial carbon and nitrogen substantially increase hardness, corrosion resistance, and fatigue resistance of the treated article. Additionally, if carried out at slightly elevated temperatures around 500° C., a precipitate layer may form on the part surface, further increasing hardness in that region. The sensitization effect (diminished corrosion resistance) common to these alloys in precipitated regions is offset by the surrounding treated material which has superior corrosion resistance relative to the base alloy. Additionally, the surface treatment produces a high compressive stress which may close pores and mitigate similar defects.

In carbonitriding, also referred to and used interchangeably herein as “nitrocarburizing,” the workpiece is exposed to both nitrogen and carbon-containing gases, whereby both nitrogen atoms and carbon atoms diffuse into the workpiece for surface hardening. In the same way as carburization and nitriding, carbonitriding can be accomplished at higher temperatures, in which case hardening occurs through the formation of nitride and carbide precipitates, or at lower temperatures in which case hardening occurs through the sharply localized stress fields that are created in the crystal lattice of the metal by the interstitially dissolved nitrogen and carbon atoms that have diffused into this lattice. For convenience, all three of these processes, i.e., carburization, nitriding and nitrocarburizing (carbonitriding), are collectively referred to in this disclosure as “low-temperature case formation,” “low-temperature surface hardening,” “low-temperature surface hardening processes,” or “hardening processes.”

### Role of Reagents in Hardening

Because the temperatures involved in low-temperature surface hardening are so low, carbon and/or nitrogen atoms may not penetrate the outer passive layers of certain metals like stainless steel. Therefore, low-temperature surface hardening of these metals is normally preceded by a step in which the shaped metal article is contacted with a halogen containing gas such as HF, HCl, NF₃, F₂ or Cl₂ at elevated temperature, e.g., 200 to 400° C., to make the steel's protective oxide coating transparent to the passage of carbon and/or nitrogen atoms (making the protective oxide coating transparent to the passage of carbon and/or nitrogen atoms is also known and referred to herein as “activating” and “depassivating”). The halide gas chemistry reduces the passive oxide film which then makes it “transparent” to the nitrogen and carbon atoms. The passive film is already transparent since it is only angstroms thick.

### SUMMARY

Disclosed herein is a treated additive manufactured article. The article comprises a shaped metal alloy having a treated surface layer and a core. At least one of the average hardness of the treated surface layer is greater than the average hardness of the core, and the average corrosion resistance of the treated surface layer is greater than the average corrosion resistance of the core.

Also disclosed herein is a method for treating an additive manufactured article by gas carburization in which the article is contacted with a carburizing gas at an elevated carburization temperature to cause carbon to diffuse into the article surfaces thereby forming a hardened surface layer of predetermined thickness and improved corrosion resistance without substantial formation of carbide precipitates. A rate of carburization is reduced during carburization so as to foster rapid carburization during an earlier stage of carburization while avoiding formation of carbide precipitates at a later stage of carburization.

Further disclosed herein is a method for treating an additive manufactured article including treating a surface layer of the article to form a hardness depth profile wherein at least one of the average hardness of the treated surface layer is greater than the average hardness of the core; and the average corrosion resistance of the treated surface layer is greater than the average corrosion resistance of the core. The method includes shaping the article.

### BRIEF DESCRIPTION OF THE DRAWINGS

FIG. 1 is a schematic of an exemplary laser powder bed fusion process.

FIG. 2 is an optical micrograph showing the cross-section of the AM puck 1 according to Example 1.

FIG. 3 is a drawing showing the configuration of Hastelloy C-22 AM pucks of Example 2.

FIG. 4 shows the testing apparatus and form of sample for testing in Example 2, as described herein.

FIG. 5 is an optical micrograph of a puck 300 polished, cross-sectional sample 500 of Example 2.

FIG. 6 is an optical micrograph of an internal gas pore 600 in sample 500.

FIG. 7 is an optical microcopy image of a sample 700 of treated AM metal with a surface treatment layer 710.

FIG. 8 shows the results of Cyclic Potentiodynamic Polarization (CPP) corrosion testing of AM articles with and without surface hardening.

### DETAILED DESCRIPTION

### Treatment Techniques for AM

As discussed above, most prior art treatment methods have been developed or optimized for articles that are forged and worked, rather than developed by AM processes. Such techniques can also have the disadvantage of not being able to target particular surfaces of the workpiece, or particular portions of workpiece surfaces, for treatment. Thus, there is a need for a way to apply the treatment processes discussed above to AM articles. There is also a need to selectively target surfaces or portions of surfaces for case hardening and/or corrosion resistance treatment. The present disclosure addresses these needs and others.

### Metal Alloys

A focus of the present disclosure is on making shaped articles from powders of metal alloys.

Suitable alloys include nickel-based alloys which can be low-temperature carburized in accordance with this disclosure include Alloy 600, Alloy 625, Alloy 825, Alloy C-22, Alloy C-276, Alloy 20 Cb and Alloy 718, to name a few examples.

Suitable alloys include low-temperature carburized iron-, nickel- and cobalt-based alloys, especially stainless steel. Mixtures of these alloys can be used. Such materials are well known and described for example in U.S. Pat. Nos. 5,792,282; 6,093,303; 6,547,888, E.U. Patent No. 0787817 and Japanese Patent Document 9-14019 (Kokai 9-268364).

Particular alloys of interest are steels, especially steels containing 5 to 50, preferably 10 to 40, wt. % Ni. Preferred alloys contain 10 to 40 wt. % Ni and 10 to 35 wt. % Cr. More preferred are the stainless steels, especially the AISI 300 series steels. Of special interest are AISI 301, 303, 304, 309, 310, 316, 316L, 317, 317L, 321, 347, CF8M, CF3M, 254SMO, A286 and AL6XN stainless steels. The AISI 400 series stainless steels and especially Alloy 410, and Alloy 416 are also of special interest.

In addition to iron- and nickel-based alloys, this disclosure can also be practiced using cobalt-based alloys as well as manganese-based alloys. Examples of such cobalt-based alloys include MP35N and Biodur CMM, while examples of such manganese-based alloys include AISI 201, AISI 203EZ and Biodur 108.

The particular phase of the metal being processed in accordance with the present disclosure is unimportant, as the disclosure can be practiced on metals of any phase structure including, but not limited to, austenite, ferrite, martensite, duplex metals (e.g., austenite/ferrite), etc.

### Reagents

As discussed above, the workpiece can be exposed to pyrolysis products of a nonpolymeric reagent comprising carbon and nitrogen. As such, treatments of the present disclosure may include exposing surfaces to a class of non-polymeric N/C/H compounds. Examples of suitable such reagents include a guanidine [HNC(NH₂)₂] moiety or functionality with or without an HCl association (e.g., complexing) for case formation. These reagents result in a case formation on the workpiece and improve hardening, corrosion resistance, and/or abrasion resistance.

In particular, results show that at least three reagents belonging to this system, 1,1-dimethylbiguanide HCl (hereinafter, “DmbgHCl”):

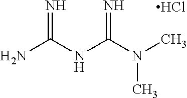

and guanidine HCl (hereinafter, “GuHCl”):

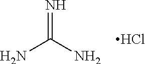

and biguanide HCl (BgHCl) have successfully induced surface property enhancements including extremely rapid surface hardening and/or corrosion resistance, as well as other surface property enhancements such as abrasion resistance, under low-temperature conditions. The guanidine [HNC(NH₂)₂] moiety or functionality with HCl complexing is the chemical structure common to both DmbgHCl, GuHCl, and BgHCl.

Other compounds including guanidine with HCl are also suitable, e.g., melamine HCl (MeHCl) and methylammonium Cl may provide similar results. Other guanidine containing compounds that might achieve similar results in this context include triguanides (the basic structure of triguanides is:

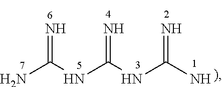

such as carbamimidoylimidodicarbonimidic diamide HCl.

Examples of guanides, biguanides, biguanidines and triguanides that produce similar results include chlorhexidine and chlorohexidine salts, analogs and derivatives, such as chlorhexidine acetate, chlorhexidine gluconate and chlorhexidine hydrochloride, picloxydine, alexidine and polihexanide. Other examples of guanides, biguanides, biguanidines and triguanides that can be used according to the present invention are chlorproguanil hydrochloride, proguanil hydrochloride (currently used as antimalarial agents), metformin hydrochloride, phenformin and buformin hydrochloride (currently used as antidiabetic agents).

As discussed above, guanidine moiety reagents may or may not be complexed with HCl. Reagent complexing with any hydrogen halide may achieve similar results. Guanidine moiety reagents without HCl complexing may also be mixed with other reagents, such as the other reagents discussed in U.S. patent Ser. No. 17/112,076, herein incorporated by reference in its entirety, having HCl complexing. They may comprise at least one functionality selected from a guanidine, urea, imidazole, and methylammonium. The reagent may be associated with HCl or Cl. The reagent may comprise at least one of guanidine HCl, biguanide HCl, dimethylbiguanide HCl, methylammonium Cl. An important criterion may be whether the reagent or mix of reagents has a liquid phase while decomposing in the temperature ranges of low-temperature nitrocarburization (e.g., 450 to 500° C.). The extent to which reagents evaporate/sublimate without decomposing before reaching that temperature range is an important consideration.

Reagents used in the treatments disclosed herein include those comprising non-polymeric N/C/H compounds. Mixtures of different non-polymeric N/C/H compounds are included. The non-polymeric N/C/H compounds may supply nitrogen and carbon atoms for case formation, e.g., carburization, nitriding, and/or carbonitriding of the workpiece. Mixtures of these compounds can be used to tailor that the particular non-polymeric N/C/H compounds used to the particular desired treatment. The non-polymeric N/C/H compounds may be used for any surface alteration including hardening, corrosion resistance, and/or any other surface property alteration described herein.

The non-polymeric N/C/H compounds that may be used in treatments disclosed herein can be a compound which (a) contains at least one carbon atom, (b) contains at least one nitrogen atom, (c) contains only carbon, nitrogen, hydrogen and optionally halogen atoms, (d) is solid or liquid at room temperature (25° C.) and atmospheric pressure, and (e) has a molecular weight of ≤5,000 Daltons. Non-polymeric N/C/H compounds with molecular weights of ≤2,000 Daltons. ≤1,000 Daltons or even ≤500 Daltons are included. Non-polymeric N/C/H compounds which contain a total of 4-50 C+N atoms, 5-50 C+N atoms, 6-30 C+N atoms, 6-25 C+N atoms, 6-20 C+N atoms, 6-15 C+N atoms, and even 6-12 C+N atoms, are included.

Specific classes of non-polymeric N/C/H compounds that can be used with the disclosed treatments include primary amines, secondary amines, tertiary amines, azo compounds, heterocyclic compounds, ammonium compounds, azides and nitriles. Of these, those which contain 4-50 C+N atoms are desirable. Those which contain 4-50 C+N atoms, alternating C═N bonds and one or more primary amine groups are included. Examples include melamine, aminobenzimidazole, adenine, benzimidazole, guanidine, biguanide, triguanide, pyrazole, cyanamide, dicyandiamide, imidazole, 2,4-diamino-6-phenyl-1,3,5-triazine (benzoguanamine), 6-methyl-1,3,5-triazine-2,4-diamine (acetoguanamine). 3-amino-5,6-dimethyl-1,2,4-triazine, 3-amino-1,2,4-triazine, 2-(aminomethyl)pyridine, 4-(aminomethyl)pyridine, 2-amino-6-methylpyridine and 1H-1,2,3-triazolo(4,5-b)pyridine, 1,10-phenanthroline, 2,2′-bipyridyl and (2-(2-pyridyl)benzimidazole). Specific triguanides include 1,3-bis(diaminomethylidene)guanidine and N-carbamimidoylimidodicarbonimidic diamide.

Also included are the three triazine isomers, as well as various aromatic primary amines containing 4-50 C+N atoms such as 4-methylbenzeneamine (p-toluidine), 2-methylaniline (o-toluidine), 3-methylaniline (m-toluidine), 2-aminobiphenyl, 3-aminobiphenyl, 4-aminobiphenyl, 1-naphthylamine, 2-naphthylamine, 2-aminoimidazole, and 5-aminoimidazole-4-carbonitrile. Also included are aromatic diamines containing 4-50 C+N atoms such as 4,4′-methylene-bis(2-methylaniline), benzidine, 4,4′-diaminodiphenylmethane, 1,5-diaminonaphthalene, 1,8-diaminonaphthalene, and 2,3-diaminonaphthalene. Hexamethylenetetramine, benzotriazole and ethylene diamine are also included.

Any reagent described herein may be associated with HCl. HCl, in some cases, may assist in de-passivation or other chemical process. In some cases, HCl association may increase the reagent phase change temperatures.

Yet another included class of compounds, in which some of the above compounds are included, are those which form nitrogen-based chelating ligands, e.g., guanidine moieties and polydentate ligands containing two or more nitrogen atoms arranged to form separate coordinate bonds with a single central metal atom. Compounds forming bidentate chelating ligands of this type are included. Examples include o-phenantrolin, 2,2′-bipyridine, aminobenzimidazol and guanidinium chloride. In addition to [HNC(NH₂)₂], guanidine moieties can be more generally represented with [R—(H₂NC═NH)]. Urea moieties with [R—NH(H₂NC=0)] are included.

Still another included type of non-polymeric N/C/H compounds are those used to produce carbon nitrides and/or carbon nitride intermediate(s) described in WO 2016/027042, the disclosure of which is incorporated herein in its entirety. The intermediate species may participate in or contribute to low-temperature activation and hardening of a workpiece. Precursors, which can include melamine and GuHCl, can form various carbon nitride species. These species, which have the empirical formula C₃N₄, comprises stacked layers or sheets one atom thick, which layers are formed from carbon nitride in which there are three carbon atoms for every four nitrogen atoms. Solids containing as little as 3 such layers and as many as 1000 or more layers are possible. Although carbon nitrides are made with no other elements being present, doping with other elements is contemplated.

Yet another included subgroup of non-polymeric N/C/H compounds included are those which contain 20 or less C+N atoms and at least 2 N atoms.

In some instances, at least 2 of the N atoms in these compounds are not primary amines connected to a 6-carbon aromatic ring, either directly or through an intermediate aliphatic moiety. In other words, although one or more of the N atoms in these particular non-polymeric N/C/H compounds can be primary amines connected to a 6-carbon aromatic ring, at least two of the N atoms in these compound should be in a different form, e.g., a secondary or tertiary amine or a primary amine connected to something other than a 6-carbon aromatic ring.

The N atoms in the non-polymeric N/C/H compounds of this subgroup (i.e., non-polymeric N/C/H compounds containing 20 or less C+N atoms and at least 2 N atoms) can be connected to one another such as occurs in an azole moiety, but more commonly will be connected to one another by means of one or more intermediate carbon atoms. Urea may also be included.

Of the non-polymeric N/C/H compounds of this subgroup, those which contain 15 or less C+N atoms, as well as those which contain at least 3 N atoms are included. Those that contain 15 or less C+N atoms and at least 3 N atoms are included.

The non-polymeric N/C/H compounds of this subgroup can be regarded as having a relatively high degree of nitrogen substitution. In this context, a relatively high degree of nitrogen substitution will be regarded as meaning the N/C atomic ratio of the compound is at least 0.2. Compounds with N/C atomic ratios of 0.33 or more, 0.5 or more, 0.66 or more, 1 or more, 1.33 or more, or even 2 or more are included. Non-polymeric N/C/H compounds with N/C atom ratios of 0.25-4, 0.3-3, 0.33-2, and even 0.5-1.33 are included.

Non-polymeric N/C/H compounds of this subgroup containing 10 or less C+N atoms are included, especially those in which the N/C atomic ratio is 0.33-2, and even 0.5-1.33.

Non-polymeric N/C/H compounds of this subgroup which contain 8 or less C+N atoms are included, especially those in which the N/C atomic ratio is 0.5-2 or even 0.66-1.5, in particular triguanide-based reagents.

In order to achieve this relatively high degree of nitrogen substitution, the non-polymeric N/C/H compounds of this subgroup can include one or more nitrogen-rich moieties examples of which include imine moieties [C═NR], cyano moieties [—CN] and azo moieties [R—N═N—R]. These moieties can be a part of a 5- or 6-membered heterocyclic ring containing one or more additional N atoms such as occurs when an imine moiety forms a part of an imidazole or triazine group or when an azole moiety forms a part of a triazine or triazole group.

These moieties can also be independent in the sense of not being part of a larger heterocyclic group. If so, two or more of these moieties can be connected to one another through an intermediate C and/or N atom such as occurs, for example, when multiple imine moieties are connected to one another by an intermediate N atom such as occurs in 1,1-dimethylbiguanide hydrochloride or when a cyano group is connected to an imine moiety through an intermediate N atom such as occurs in 2-cyanoguanidine. Alternatively, they can simply be pendant from the remainder of the molecule such as occurs in 5-aminoimidazole-4-carbonitrile or they can be directly attached to a primary amine such as occurs in 1,1-dimethylbiguanide hydrochloride, formamidine hydrochloride, acetamidine hydrochloride, 2-cyanoguanidine, cyanamide and cyanoguanidine monohydrochloride.

In the non-polymeric N/C/H compounds that contain one or more secondary amines, the secondary amine can be part of a heterocyclic ring containing an additional 0, 1 or 2 N atoms. An example of such compounds in which the secondary amine is part of a heterocyclic ring containing no additional N atoms is 1-(4-piperidyl)-1H-1,2,3-benzotriazole hydrochloride. Examples of such compounds in which the heterocyclic ring contains one additional N atom are 2-aminobenzimidazole, 2-aminomethyl benzimidazole dihydrochloride, imidazole hydrochloride and 5-aminoimidazole-4-carbonitrile. An example of such compounds in which the secondary amine is part of a heterocyclic ring containing two additional N atoms is benzotriazole. Alternatively, the secondary amine can be connected to a cyano moiety such as occurs in 2-cyanoguanidine and cyanoguanidine monohydrochloride.

In the non-polymeric N/C/H compounds of this subgroup which contain one or more tertiary amines, the tertiary amine can be part of a heterocyclic ring containing an additional 1 or 2 N atoms, an example of which is 1-(4-piperidyl)-1H-1,2,3-benzotriazole hydrochloride.

In some variations, the non-polymeric N/C/H compound used will contain only N, C and H atoms. The particular non-polymeric N/C/H compound used will be halogen-free. In other aspects of the present disclosure, the non-polymeric N/C/H compound can contain or be associated or complexed with one or more optional halogen atoms.

One way this can be done is by including a hydrohalide acid such as HCl in the compound in the form of an association or complex. If so, this non-polymeric N/C/H compounds is referred to in this disclosure as being “complexed.” On the other hand, if the non-polymeric N/C/H compound has not been complexed with such an acid, then it is referred to in this disclosure as being “uncomplexed.” In those instances in which neither “complexed” nor “uncomplexed” is used, it will be understood that the term in question is inclusive and refers to both complexed and uncomplexed non-polymeric N/C/H compounds.

The non-polymeric N/C/H compounds of the present disclosure can be complexed with a suitable hydrohalide acid such as HCl and the like (e.g., HF, HBr and HI), if desired. In this context, “complexing” will be understood to mean the type of association that occurs when a simple hydrohalide acid such as HCl is combined with a nitrogen-rich organic compound such as 2-aminobenzimidazole. Although the HCl may dissociate when both are dissolved in water, the 2-aminobenzimidazole does not. In addition, when the water evaporates, the solid obtained is composed of a mixture of these individual compounds on an atomic basis—e.g., a complex. It is not composed exclusively of a salt in which Cl− anions from the HCl are ionically bound to N atoms in the 2-amionbenzimidazole which N atoms have been made positive by taking up H+ cations derived from the HCl.

Any suitable form of any reagent described herein may be used with this disclosure. This includes, powder, liquid, gas and combinations thereof. As used herein, “reagents” includes any substance, including a non-polymeric N/C/H compound or other compounds used in the altering of metal surface properties and/or case formation.

### Treatments

Treatments according to this disclosure encompass any treatment described herein directly or by reference. These treatments include carburizing, nitriding, and nitrocarburizing at temperatures less than 700° C. or less than 500° C. They may alter various properties of the material, including hardness and/or corrosion resistance. The treatments further include carburizing, nitriding, and nitrocarburizing for times less than 3 days or fewer, 1 day or fewer, 12 hours or fewer, 8 hours or fewer, such as 2 hours or fewer or even 1 hour or less. Treatments according to this disclosure also include exposing a surface of an article to vapors produced by low-temperature pyrolysis of any of the reagents, or combination of the reagents, described herein. They also include exposure of the article to any of the gases and/or coatings disclosed herein. The exposure to the vapors may occur during, after, or before any one or more of carburizing, nitriding, and nitrocarburizing.

In certain aspects of this disclosure, the one or more of carburizing, nitriding, or nitrocarburizing comprises: modifying an area of the first surface, and one or more of carburizing, nitriding, or nitrocarburizing the article to change the hardness and/or corrosion resistance of at least a portion of the first surface. In certain aspects, the modifying an area comprises applying a chemical that facilitates or enhances the one or more of carburizing, nitriding, or nitrocarburizing of the modified area. In certain aspects, the one or more of carburizing, nitriding, or nitrocarburizing the article increases the hardness and/or corrosion resistance of the modified area. In certain aspects, the chemical comprises at least one of Dimethylbiguanide HCl, Guanidine HCl, Biguanide HCl, or cyclic triguanides (e.g., Melamine HCl), linear triguanide isomers (e.g., Bis(diaminomethylidene)guanidine HCl, Carbamimidoylimidodicarbonimidic diamide HCl), and any other reagents listed above. In aspects, the chemical comprises at least one of melamine, another staged-non-reacted polymer, mineral oil, a water-based polyethylene oxide coating, a water-based polypropylene oxide coating, or simple appropriate solvent mixes having a boiling point temperature below the melting point of the one or more reagents in solution.

In certain aspects, the modifying an area comprises applying a substance that substantially prevents carburizing, nitriding, or nitrocarburizing of the modified area. In aspects, the one or more of carburizing, nitriding, or nitrocarburizing the article increases the hardness and/or corrosion resistance of at least a portion of the first surface other than the modified area. In aspects, the applied substance is copper or another metal. In aspects, the modifying an area comprises at least one of powder coating, electrostatic powder coating, fluidized bed, and centrifugal force-controlled spin coating.

### Articles to be Treated

Articles to be treated, in the context of this disclosure, include any article produced by AM techniques whether explicitly disclosed herein or not. They include articles produced by AM using powdered metal including any of the alloys described above. Two or more alloys may be used to fabricate a multi-material additive manufactured article. These include powder bed fusion (PBF), fused deposition modeling (FDM), and direct energy deposition (DED). In aspects of the disclosure, AM articles are subject to post-build processing, e.g., for densification and reduction of porosity (e.g., HIP). In aspects, the treatment is performed before the post-build processing. In aspects, it is performed on the powder used to make the article via AM. After treatment, in aspects of the disclosure, the articles have a hardened and/or corrosion-resistant surface layer.

After treatment, in aspects of the disclosure, the articles have a hardened surface layer. In aspects, the hardened surface layer extends up to about 25 μm from the surface of the article. In aspects, the hardened surface layer extends 2.5, 3.0, 3.5, 4.5, 5, 7, 8, 10, 15, or 20 μm from the surface into the article. In aspects, the core or interior of the article extends from edge of the hardened surface layer into the bulk of the article. In aspects, the core or interior of the article has a substantially lower hardness than this treated, hardened surface layer. For example, in aspects, the core has a hardness that is only around 50% of the hardness of the hardened surface layer (i.e., the surface layer is at least 50% harder than the core). In aspects, the core has a hardness that up to 50%, including less than 40%, less than 30%, less than 20%, and less than 10% of the hardness of the hardened surface layer. Unless otherwise indicated, hardness comparisons herein are based on Vickers hardness test. However, it is to be understood that the comparisons apply to other hardness methods as well.

After treatment, in aspects of the disclosure, the articles have a surface with improved corrosion resistance. In aspects, the surface layer extends up to about 25 μm from the surface of the article. In aspects, the surface layer with improved corrosion resistance extends 2.5, 3.0, 3.5, 4.5, 5, 7, 8, 10, 15, or 20 μm from the surface into the article. In aspects, the core or interior of the article extends from edge of the surface layer into the bulk of the article. In aspects, the core or interior of the article has a substantially lower corrosion resistance than this treated surface layer. For example, in aspects, the core material will fail more often under Critical Crevice Temperature (CCT) testing more than the surface material will. For example, some CCT tests may show the core failing up to 100% of the time, while the surface does not fail. Some CCT tests may show the core fail up to 83%, 67%, 50%, or 20% of the time, when the surface does not fail. Unless otherwise indicated, corrosion resistance comparisons herein are based on CCT tests. However, it is to be understood that the comparisons apply to other hardness methods as well.

The hardened surface layer may comprise multiple layers, each of the multiple layers having a different hardness. In particular, the hardened surface layer may have a dual layer structure as described in U.S. patent application Ser. No. 17/112,076 “CHEMICAL ACTIVATION OF SELF-PASSIVATING METALS,” to Cyprian Illing et al., filed on Dec. 4, 2020 (hereinafter the “'076 Application”), incorporated herein by reference in its entirety. For example, the hardened surface layer may have an outer layer that is harder than an inner layer. The outer lay may have an increased amount of nitrogen and a decreased amount of carbon (or vice versa). The outer layer may include fine precipitates of carbon and/or nitrogen as primarily interstitial nitrogen.

After treatment, in accordance with the present disclosure, the hardened surface layer of the article includes nitrogen and carbon. In aspects, it includes nitrides and carbides as fine precipitates. In aspects, the hardened surface layer has a carbon concentration of 5 to 15 atomic % and a nitrogen concentration of 5 to 15 atomic % but is substantially free of coarse carbide or nitride precipitates. In aspects, the hardened surface layer comprises one or more of fine nitride and fine carbide precipitates. In aspects, the nitrogen in the hardened surface layer is present primarily as interstitial nitrogen. In aspects, the hardened surface layer includes compressive stress due to the presence of interstitial carbon and nitrogen. In aspects, that compressive stress changes the microstructure of the hardened surface layer.

In accordance with the present disclosure, the stress partially or fully closes pores in the hardened surface layer. In aspects, it thereby improves the corrosion resistance and/or mechanical properties of the article. The hardened surface layer may have a porosity of less than 1%, 0.3%, 0.1%, 0.03%, even 0.01%. In aspects, the hardened surface layer has a compressive stress of 1 GPa, 1.5 GPa, 2.0 GPa, 2.5 GPa, 3.0 GPa or greater. In aspects, the hardened surface layer has a substantially increased corrosion resistance with respect to a corrosion resistance of the core or adjacent inner layer. In aspects, the hardened surface layer is produced by one or more of carburizing, nitriding, and nitrocarburizing at the temperature of less than 700° C., 650° C., 600° C., 550° C., 500° C., or 450° C. In aspects, the one or more of carburizing, nitriding, and nitrocarburizing is completed in 5 days, 3, days, 1 day, 8, 6, 4, or 2 hours or fewer. In aspects, the one or more of carburizing, nitriding, and nitrocarburizing comprises producing vapors by decomposing a reagent, exposing the article to the vapors, and surface hardening the article to form the surface layer via one or more of carburizing, nitriding, and nitrocarburizing.

In aspects, the article comprises a second surface that may have not been subject to a treatment. In aspects, the treated first surface is on one or more of a conduit, channel, groove, valve bonnet opening, or cavity of the article. In aspects, the article is subject to one or more of stress-relieving before, during, or after the one or more of carburizing, nitriding, and nitrocarburizing, hot isostatic pressing the article before the one or more of carburizing, nitriding, and nitrocarburizing, bead blasting before the carburizing, nitriding, and nitrocarburizing to at least one of: reduce a time of carburizing, nitriding, and nitrocarburizing, improve consistency of hardening; or a combination of both reduce a time of carburizing, nitriding, and nitrocarburizing and improve consistency of hardening, and polishing after the carburizing, nitriding, and nitrocarburizing to at least one of reduce porosity, remove asperities, or a combination of both reduce porosity and remove asperities.

### Exemplary Treatment Results

Results disclosed herein show that at least one of two reagents belonging to the methods in accordance with the present disclosure, 1,1-Dimethylbiguanide HCl (hereinafter, “DmbgHCl”):

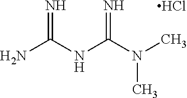

and Guanidine HCl (hereinafter, “GuHCl”):

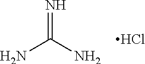

have successfully induced extremely rapid hardening of AM articles under low-temperature conditions. Specifically, 8 mg of either reagent, tested separately, was able to achieve ˜7 μm of a hardened case depth after 2 hours of low-temperature (500° C.) treatment. The reagents were pyrolyzed to produce vapors in the presence of a Haselloy C-22 article. The article was exposed to those vapors before, during, and/or after at least one of low-temperature carburizing, nitriding, and nitrocarburizing. AM 316L SS articles will respond similarly.

Other results confirm rapid hardening by DmbgHCl and GuHCl in other systems. Specifically, 8 mg of either reagent, tested separately, was able to achieve ˜7 μm of a hardened case depth after 2 hours of low-temperature (500° C.) treatment. The reagents were pyrolyzed to produce vapors in the presence of a wrought Hastelloy C-276 article. The article was exposed to those vapors before, during, and/or after at least one of low-temperature carburizing, nitriding, and nitrocarburizing.

Treatments using some of the above gases/reagents are understood to introduce interstitial carbon and/or nitrogen to a surface portion of the AM material. Under conditions of low-temperature interstitial treatment (e.g., performing nitrocarburization at temperatures from 450-500° C.), such as those described in U.S. Pat. No. 10,214,805, coarse (e.g., precipitates having an average diameter about 5 μm or greater) carbide and nitride precipitates likely do not form in many metals. The temperatures are likely too low for the substitutional diffusion of chromium and other metal atoms necessarily for coarse course carbides to precipitate, at grain boundaries, for example. In fact, as described in more detail above, avoiding deleterious carbide and nitride precipitates, understood to be coarse precipitates, is one of the reasons for treating under these conditions.

Instead, as discussed in more detail in the '076 Application, overlapping carbon and nitrogen concentration concentrations have been observed as a result of hardening process described therein. Since coarse carbides and nitrides are likely ruled out by kinetics of performing nitrocarburization at temperatures from 450-500° C., these carbon and nitrogen concentrations are believed to represent either interstitial concentrations or fine precipitates (e.g., precipitates having an average diameter about 0.5 μm or smaller). Id.

The treatments are thought to increase corrosion resistance, due to the increased corrosion resistance of the layers rich in interstitial nitrogen and carbon rich layers. More specifically, inclusion of interstitial nitrogen and carbon in the metal lattice is believed to cause a substantial compressive stress. In some cases, the resultant compressive stress may be sufficient to partially or completely close off porosity just below the surface. Doing so can increase corrosion resistance by excluding pore surface area from attack by potentially aggressive chemicals. As discussed above, most AM techniques leave measurable porosity in surface layers because they fuse discreet, particles to create the article. Until and unless densification processes are performed (e.g., HIP), this may leave voids, pores, or other microstructure in the article. Shielding interior, pore surfaces from aggressive, ambient chemicals cuts off a major mechanism for corrosion.

This effect of increasing corrosion resistance may be enhanced by performing a stress relief treatment (e.g., by heating to temperatures of 400° C. or above) after or during the treatment disclosed herein. The stress relief procedures may improve both corrosion resistance and mechanical properties without substantially increasing processing times.

In addition to increasing corrosion resistance, the above-described stress induction may also increase mechanical properties of the AM material. Generally, the resultant reduction in porosity may increase strength and strain resistance.

The treatment processes described herein may be performed before subtractive manufacturing (SM), mechanical deformation, or other modification of the AM article. In certain cases, it may be advantageous to treat the material after any one or more of these processes so that the finished material retains the hardened and/or corrosion resistant characteristics. In others, it may be advantageous to treat the material mid-process or before the process so that certain process results are enhanced by the hardening and/or corrosion resistance. Examples include treating the inner channels of manifolds prior to polishing to provide a reduction in polishing time with less gouging or deformation of the channel surface.

After treatment, several subsequent procedures may be applied to enhance the properties of the article. For example, the surfaces of the treated AM material may be further mechanically worked to increase hardening. Examples of processes that may further mechanically work the material include bead blasting, shot peening, hammering, and other processes that cause plastic deformation of the material surface. In addition or in alternative, any of these procedures may be applied prior to the treatment herein. Other procedures that may be applied include surface polishing. Internal surfaces (e.g., pore surfaces) may be polished using abrasive media, such as sandpaper, and/or sandblasting using abrasive liquid, etc. These treatments may also be applied prior to treatment processes as applied herein. Polishing prior to hardening may reduce the time necessary to achieve a hardening to typically a depth of 20 μm during the treatment processes disclosed herein. It may also reduce surface asperities sufficiently to decrease inconsistencies and hardness resulting from the hardening processes.

Polishing using materials and/or powders hardened by the treatment processes herein may have certain advantages. For example, polishing materials with polishing grit made from the same material subject to the treatment processes described herein may effectively polish without introducing substantial contamination, since the polishing grit and polished material have similar or essentially the same chemical composition.

To the extent that any of these processes (polishing, abrasion, working, bead blasting, shot peening, etc.) cause plastic deformation of the surface of the article, they may introduce layers of deformation (e.g., Beilby layers). As described herein and in the references incorporated herein, the techniques of the present disclosure can treat materials despite the existence of such layers of deformation.

Performing the hardening prior to other treatments may also be advantageous. For example, post-hardening polishing may benefit from reduced polishing times due to reduction of surface porosity resulting from, among other things, the above-described surface compressive stress induced by hardening or due to the formation of a less adherent carbide or nitride layer. This may further increase the rapid removal of hardened surface asperities, more easily removed by virtue of their hardness and corresponding resistance to plastic deformation.

### EXAMPLES

The treatment processes described above has been successfully demonstrated on AM articles.

### Example 1: AM 316L Stainless Steel

In Example 1, 316L stainless steel material was printed via Laser Powder Bed Fusion (LPBF) to create a bulk AM sample. ¾ inch diameter cylinders were cut into ¼ inch thick pucks (not shown) to provide samples for the study. The pucks 1 were then stress relieved by heating at 750° F. (400° C.). One side of the puck was polished.

The polished surfaces of the pucks were then hardened by the process disclosed in U.S. Pat. No. 6,547,888, the entirety of which is herein incorporated by reference. More specifically, manufactured the pucks were cleaned to remove organic residue, and dried. The pucks were then placed in a furnace and activated by contact with 20% HCl in N₂ at 300° C., then heated 450° C. and low temperature carburized in a mixture of CO, H₂, N₂. After approximately two hours of carburization, the carburization process was interrupted. The pucks were then reactivated by contact with 20% HCl in N₂ at 300° C. The carburization process was resumed at 450° C. in a mixture of CO, H₂, N₂ for an additional 15 hours. Subsequently, the pucks were cooled to room temperature via the process described in U.S. Pat. No. 6,547,888.

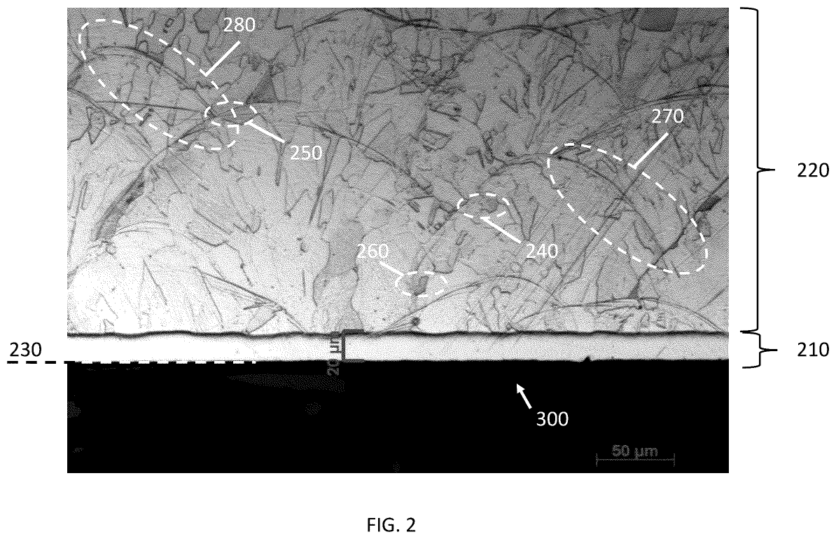

FIG. 2 is an optical micrograph showing the cross-section of the AM puck 1 according to Example 1 after the treatment described above. The cross-section 200 of puck 1 has two portions, a surface treated portion 210 and a bulk portion 220. As shown in FIG. 2, the surface treated portion 210 extends from the outer surface 230 of puck 1 around 20 μm.

Surface treated portion 210 and bulk portion 220 have visibly distinct structures, confirming the efficacy of the hardening treatment. For example, bulk portion 220 exhibits microstructure (e.g., 240, 250, and 260). Yet surface treated portion 210 exhibits essentially no visible microstructure. Carbon and nitrogen presence in the surface treated material may change how it reacts to corrosive media (the etchant) because of induced changes to its electronic structure. In some cases, compressive stresses from interstitial nitrogen and/or carbon added during hardening may also have an effect. Bulk portion 220 also exhibits segments (see, e.g., 270 and 280), which are weld pool boundaries. No such microstructure or pool boundaries appear in the treated portion 210.

### Example 2: Hastelloy C-22 (“HC-22”)

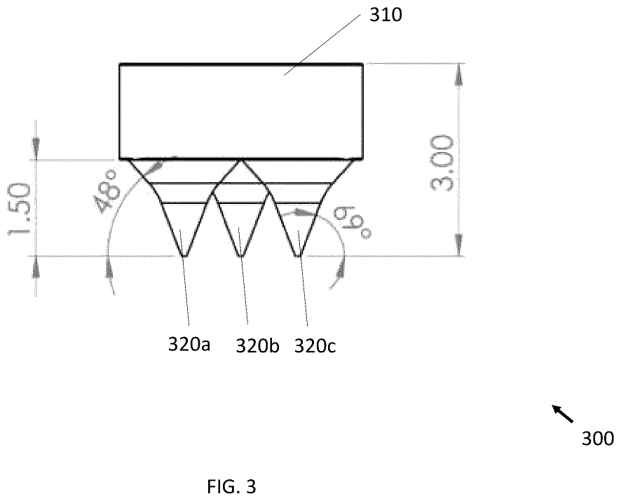

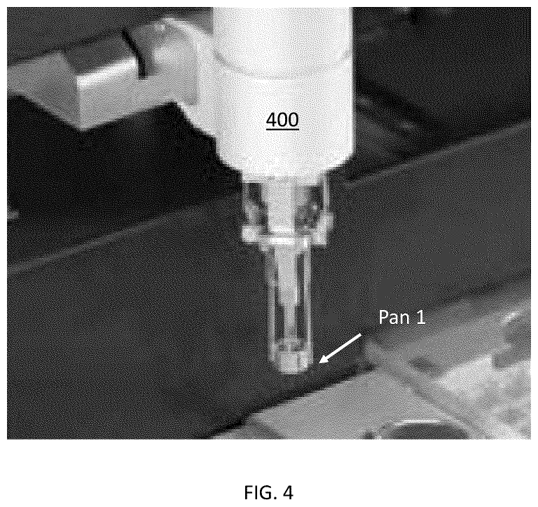

In a second example, HC-22 AM pucks 300 (FIG. 3) on risers 320a-320c with a 3.8 mm diameter and thickness of 1.5 mm (3.0 mm total) were placed in pans 1 shown in FIG. 4. In this example, the pans 1 are not case hardened along with the pucks 300.

Element 400 shown in FIG. 4 is the Netzsch Simultaneous Thermal Analysis (STA) test equipment. See The Netzsch Simultaneous Thermal Analysis (STA) equipment is described in more detail in “Fourier Transform of Infrared (FT-IR) Spectrometers Coupled to Thermal Analysis: Concepts, Instruments and Applications from RT to 2000° C., Analyzing and Testing,” NGB-FTIR-EN-0220-NWS. The pans 1 have a diameter of about 0.5 cm and a height of about 1.0 cm. There were no other significant surface preparations. In the second example, pucks 300 were case-hardened according to the procedures disclosed in U.S. Pat. No. 10,214,805, with the following modifications:

TABLE 1

| | | Hardening of AM SAE 316L |
|---|---|---|
| | U.S. Pat. No. 10,214,805 | Steel in Pan 1 |
| Equipment providing | Kenmore production, as disclosed | Netzsch Simultaneous Thermal |
| surface treatment | in U.S. Pat. No. 10,214,805. | Analysis (STA) equipment. |
| Reaction vessel conditions | Constant volume (sealed glass | Constant pressure (reaction |
| | vessel). | vessel vented). |
| Hydration conditions | Not fully dehydrated—likely | Dehydrated |
| | exposed to moisture. | Due to the reagent being |
| | Testing showed that moisture | hygroscopic and placed in pans |
| | reacts and causes chemical | just prior to hardening. |
| | changes with various reagents | |
| | used in U.S. Pat. No. | |
| | 10,214,805. | |
| Reagent | Various | Dimethylbiguanide HCl |
| | | (DmbgHCl): |
| | | 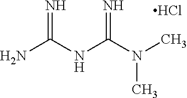 |
| | | Guanidine HCl (GuHCl): |
| | | 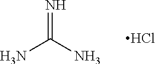 |

The pucks 300 were DI water ultrasonic cleaned, acetone rinsed, and dried. The pucks 300 was then placed in pan 1, with 8.0 mg of Dimethylbiguanide HCl reagent in an Al₂O₃ crucible. They were then heated in an N₂ atmosphere to 550° C. at a 25 K/min ramp rate. They were then held at 550° C. for 30 minutes before cooling.

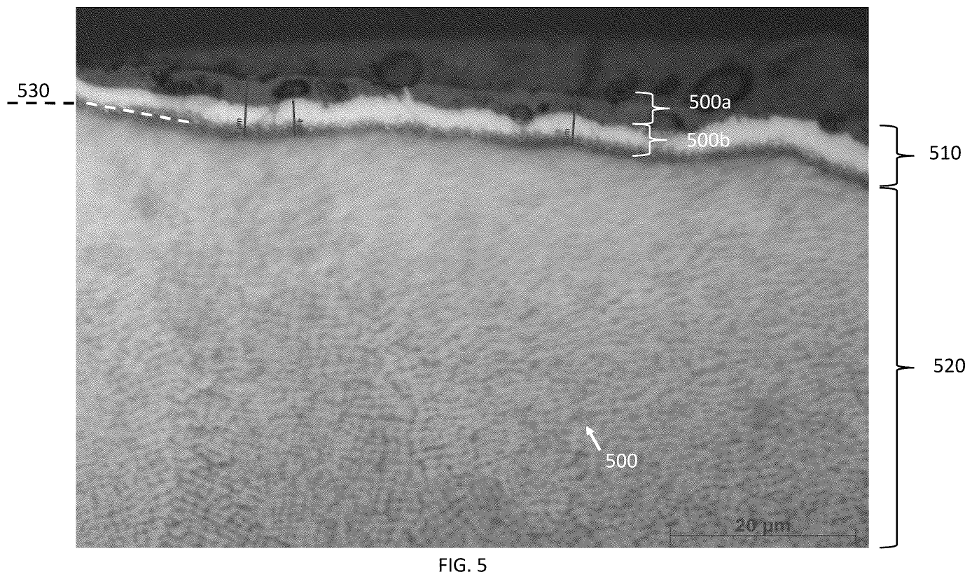

FIG. 5 shows an optical micrograph of a puck 300 polished, cross-sectional sample 500. As shown in FIG. 5, sample 500 shows a surface treated layer 510 that is visibly distinct from the bulk or core 520, separated by border 530. FIG. 5 shows that the treated surface layer 510 has a thickness of approximately 7 μm. Treated surface layer 510 comprises two sublayers, an outer (dark) sublayer 510a and inner (bright) 510b sublayer. Sublayers 510a and 510b were revealed after etching cross-sectional sample 500 with Kane's etchant. These results were similar to those obtained performing a similar hardening process on non-AM 316SS. See '076 Application. Auger electron spectroscopy depth profiles of the non-AM 316SS showed that the outer layer was rich in nitrogen, while the inner layer was relatively rich in carbon. Id.

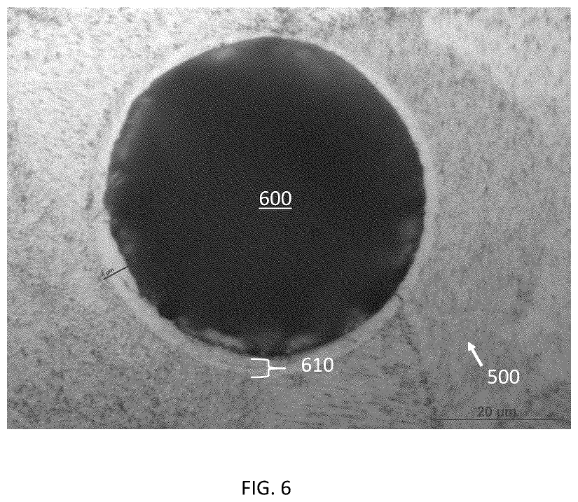

FIG. 6 shows an internal gas pore 600 in sample 500. FIG. 6 shows evidence of significant surface treatment in the gas pore, as evidence by visible treated layer 610. The treated layer 610 appears to be a single layer, with little evidence of a bi-layer (e.g., 510a/510b of treated layer 510 in FIG. 500). This may be because ore 600 was exposed to atmosphere during only part of the treating process described above (i.e., was hardened for a truncated or lesser time frame as the outer surface 510 in FIG. 5). In this case, the gas evolved from the reagents described above may have entered a narrow channel to reach and harden the inner surface 610 of pore 600.

### Example 3: L-PBF AM HC-22 with GuHCl Powder

GuHCl powder was added to an as-printed L-PBF AM HC-22 coupon. The coupon was then heated in N₂ gas at a rate of 25 K/min from room temperature to 550° C. The 550° C. temperature was held for 30 minutes before cooling by ending the application of heat. Optical microscopy revealed a hardened surface depth of 7 μm. Correlation of the optical results with chemical analysis (XEDS) showed that the hardened surface had an outer layer rich in nitrogen showing up as a darker layer. The same results showed a lighter color, carbon-rich inner layer. The inner layer included etched substrate material. Both inner and outer layers of the hardened surface exhibited improved corrosion resistance as shown by etching with Kane's etchant where the core material suffered significant etching attack while the hardened surface layers showed negligible attack relative to the non-treated core material. Treatment was even and conformal around the part. The process treated particle (powder) melting boundaries in the surface created during L-PBF.

### Example 4: L-PBF AM HC-22 with GuHCl and GuHCl/Glycerol Paste

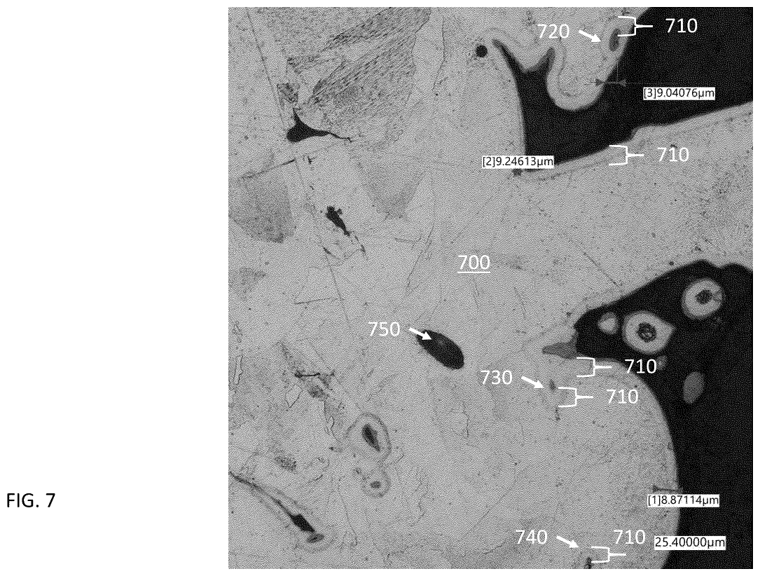

As-printed L-PBF AM HC-22 samples were first treated with GuHCl (84 wt. %) and glycerol (16 wt. %) either by coating or adding the GuHCl/glycerol as dry powder. The samples were heated in N₂ at a rate of 20 K/min from room temperature to 550° C. The 550° C. temperature was held for 30 minutes before cooling by ending the application of heat. Optical microscopy revealed a hardened surface depth of 8-9 μm. Optical microscopy images also showed effective surface treatment of surface-connected pores. FIG. 7 shows a sample 700 with a surface treatment layer 710. Multiple surface-connected pores (e.g., 720, 730, and 740) exhibiting the layer of surface treatment 710. While non-surface pores (e.g., 750) do not appear to have been treated, such pores would not be exposed, via the surface, to corrosive environments. Given the results (above) showing increased corrosion resistance in the hardened layer, this result indicates a particular advantage decreasing crevice corrosion that may form in such pores. This effect is explored in Example 5.

### Example 5: Critical Crevice Temperature (CCT) Corrosion Testing of Wrought and AM Articles with and without Surface Hardening

CCT according to ASTM G48 Method D was conducted on samples of HC-22 to determine relative susceptibility to crevice corrosion attack. Four sample groups were tested. Two groups were made of L-PBF AM HC-22. The L-PBF AM HC-22 samples were stress relieved at 790° C. for 6 hours, annealed at 1065° C. for 2 hours and cooled with a water quench. Two other groups were made of wrought HC-22. The wrought samples were annealed at 1120° C. for 1 hour and cooled with a water quench.

All samples were assembled according to the ASTM G48 Method D standard and immersed in the standard specified acidified FeCl₃ solution at 75° C., 80° C., or 85° C. for 72 hours. One group of samples from of each base material (L-PBF AM HC-22 or wrought HC-22) was not surface treated. These untreated samples are referred to herein as “Annealed.” Another group of samples, herein referred to as “Annealed Surface Hardened,” was treated with GuHCl powder and heated in N₂ at a rate of ˜20 K/min to 550° C. with a 30 minute isotherm before cooling to room temperature. Optical microscopy showed that the Annealed Surface Hardened samples had a surface hardened zone depth of ˜5 μm. Results are shown in Table 2.

TABLE 2
Critical Crevice Temperature Test Results
ASTM G48 Method D
Annealed Surface Hardened Wrought HC-22
75° C.: 0/5 samples failed
80° C.: 0/6 samples failed
85° C.: 0/6 samples failed
Annealed Surface Hardened L-PBF AM HC-22
75° C.: 0/6 samples failed
80° C.: 0/6 samples failed
85° C.: 0/6 samples failed
Annealed Wrought HC-22
75° C.: 4/5 samples failed
80° C.: 6/6 samples failed
Annealed L-PBF AM HC-22
75° C.: 1/5 samples failed
80° C.: 5/6 samples failed

As shown in Table 2, no Annealed Surface Hardened samples of either Wrought or L-PBF AM HC-22 failed (i.e., suffered observable crevice corrosion attack) at 75° C., 80° C., or 85° C. This is in stark contrast with the untreated or “Annealed” samples. Four of the five Annealed Wrought HC-22 samples failed testing criteria at 75° C. One of the five Annealed L-PBF AM HC-22 samples failed at 75° C. All six Annealed Wrought HC-22 samples and five of the six Annealed-PBF AM HC-22 samples failed testing criteria for crevice attack at 80° C.

### Example 6: Cyclic Potentiodynamic Polarization (CPP) Corrosion Testing on Hardened and Non-Hardened AM Coupons in CaCl₂ Solution at 90° C.

CPP corrosion testing provides a method for predicting the propensity of an alloy to corrode at pits and crevices. It was conducted on both non-treated and surface treated L-PBF AM HC-22 samples. Because of the innate corrosion resistance of HC-22, an aggressive electrolyte was chosen to test corrosion resistance than used in the ASTM G61 test standard. All other test parameters were consistent with the standard. The electrolyte consisted of de-aerated 5M CaCl₂ at 90° C. The reference electrode was a saturated calomel electrode (SCE). The base material was stress relieved at 790° C. for 6 hours, annealed at 1065° C. for 2 hours and cooled with a water quench. The surface treated sample was prepared identically to the non-treated samples, other than being treated with GuHCl powder and heating samples in N₂ at a rate of 20K/min to 550° C. with a 30 m isotherm before cooling to room temperature. Treated samples show a surface hardened zone depth of ˜5 μm using optical microscopy.

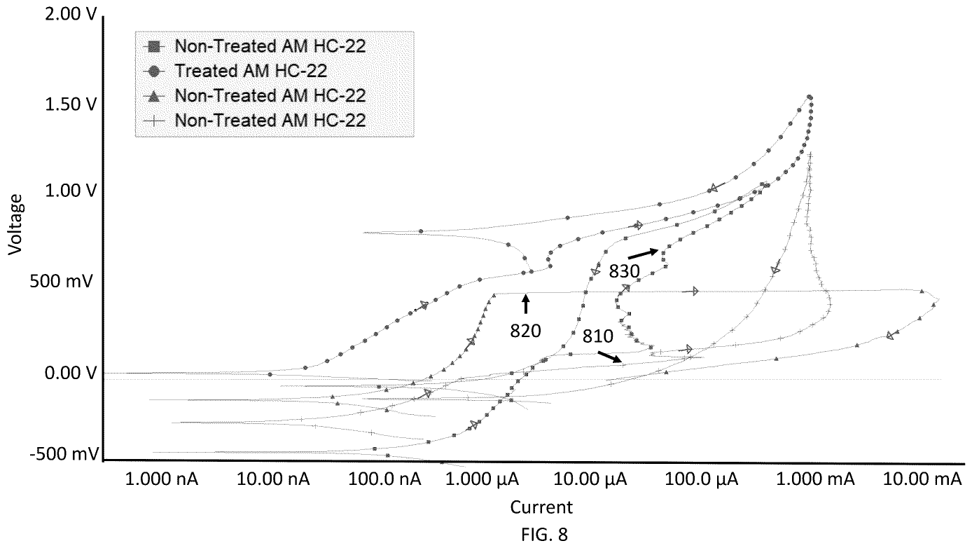

FIG. 8 shows CPP results for treated and non-treated AM samples. CPP data for the treated sample is shown via dark squares. All other data is for non-treated samples. In CPP, voltage is cycled and ramped to a maximum and current is measured through the material under potentially corrosive conditions. If pitting occurs, there will be a spike in current at the “breakdown” voltages, or when the pit forms. This is clearly seen in FIG. 8 for the three non-treated samples at 810 and 820. Sample 830 does not show gross pitting, but shows significant metastable pitting during polarization—which indicates susceptibility to pitting corrosion. The treated sample shows no such breakdown. These results indicate that treated AM articles are less susceptible to pitting attack in this aggressive electrolyte than non-hardened articles. Although the non-hardened samples showed some variability in results, but each suffered significant corrosion attack—likely due to porosity and incomplete powder fusion which act as crevices and pit initiation sites. The treatment shown here counteracted such effects by significantly increasing corrosion resistance of the alloy surface outside of- and within such possible defects.

### Reagent Azeotropes

In addition to the configurations described above, reagents can be combined in various azeotropes. An azeotrope is a mixture of liquids which has a constant boiling point and composition throughout evaporation. The azeotrope evaporation temperature may be near equal to or greater than the boiling points of the pure forms of either of the two liquids in the mixture.

Reagent azeotropes may be used in the context of the present disclosure to advantageously combine reagents to enhance or improve reagent properties for use in activation and hardening.

For example, melamine may be combined with a guanide reagent (such as any of the guanide reagents discussed above) in an azeotrope to facilitate use of melamine in certain hardening processes. Melamine, a cyclic Tri-Guanide (without HCl association) by its chemical nature should assist rapid activation and hardening of the alloys discussed herein. However, in its pure form, melamine can be inconvenient for activation and hardening applications. This is because pure melamine evaporates at a temperature too low to facilitate hardening by some of the processes disclosed herein. Combining melamine with an appropriately chosen liquid in an azeotrope can effectively raise its evaporation temperature. For example, when melamine is mixed with another guanide-like reagent, the mixture may have a greater azeotrope evaporation temperature. This may make the melamine portion of the mix more useful for inducing hardening at appropriate temperatures. The guanide-like reagents that may be used to for azeotropes with melamine include Biguanide HCl, Dimethylbiguanide HCl, Guanidine HCl. Weight proportions may vary. Exemplary melamine to guanide-like weight proportions in the azeotrope include 5% to 95%, 10% to 90%, 25% to 75%, or 50% to 50%. Other compounds may also be included in the reagent or azeotrope mixture as needed. For example, a mixture of melamine and guanide-like regent may further include an additional regent, or other compounds that may enhance certain properties of the reagent mixture.

Although combining melamine with a guanide-like reagent is discussed above as an exemplary azeotrope, it is to be understood that any suitable combination of the reagents explicitly described herein or included by reference is possible. Melamine may be combined with other reagents. Moreover, mixtures of three or more reagents are also possible, as described above to, for example, facilitate formation of an azeotrope.

Methods for creating a reagent mixture for an azeotrope may include fusing or melting reagents together at a temperature lower than the boiling point of the individual reagents. The melting point of the resultant mixture or azeotrope may be below the melting points of either of the mixed reagents when pure. Alternatively, a reagent mixture for such an azeotrope may be created by suspending the two or more reagents in a solvent, or finely distilled petroleum distillates (e.g., paint). The solvent may then be removed to leave a reagent mixture. For example, one method of removing the solvent would be to evaporate it on a metal or ceramic surface leaving a dry two-reagent mixture.

### Surface Modification

According to an aspect of the present disclosure, surfaces of AM articles are treated by covering with coatings (e.g., coatings including reagents) that enhance the hardening processes described herein. In some cases, the coating includes a reagent may also or alternatively facilitate or enhance heat treatments to portions of the surface of the component. Other coatings (e.g., copper or other metal coatings) block or mask the hardening treatment from reaching certain surfaces, thus selectively applying the hardening treatment. Some coatings include various components in addition to the reagent, e.g., a vehicle (i.e., any chemical or substance that supports and/or conveys the reagent, such as a solvent, powder, paste, spray, dip, and colloid) to facilitate coating application, wetting, and/or adherence to the component surface.

Solvent mixes containing appropriate stoichiometric or volumetric amounts of reagent are used to coat some components. They selectively coat finished valve-product media contacting passages or hardened tooling produced by additive manufacture. This process may have some similarities to flux applications for electronic components.

One example coating imparts corrosion resistance to an AM article. Some coatings create a non-homogeneous top layer amalgam of iron or nickel-based alloy metal atoms. Some coatings comprise one or more metallic phases, including at least one or more of austenite, martensite, and ferrite. Some coatings contain one or more of interstitial carbon atoms, interstitial nitrogen atoms, dispersion of minute metal carbide precipitates, dispersion of minute metal nitride precipitates, coarse metal carbide precipitates, and coarse metal nitride precipitates.

After the coating is applied, in aspects, a treatment uses the coating to alter properties of the underlying component. For example, in aspects, the coatings facilitate or enhance hardening processes, such as nitriding, carburizing, and nitrocarburizing in the hardening processes discussed above and in the references cited herein. Treating the applied coating (e.g., by heating to decompose its reagent), in aspects, facilitates or enhances hardening. In aspects, treating the applied coating provides nitrogen or carbon for hardening processes.

Coatings are applied to the materials discussed above and in the references cited herein, and according to one or more of the following exemplary variations. For example, coatings are applied to various metals, including various steels (e.g., stainless steels such as 316SS) and nickel steel alloys. They are applied before or during a hardening and/or heating process. The coatings are applied selectively to specific portions of the component surface (e.g., wetted flow paths, internal flow paths, flange, ferrule, sharp-edge, etc.) to be subjected to a specific treatment facilitated by the coating (e.g., hardening).

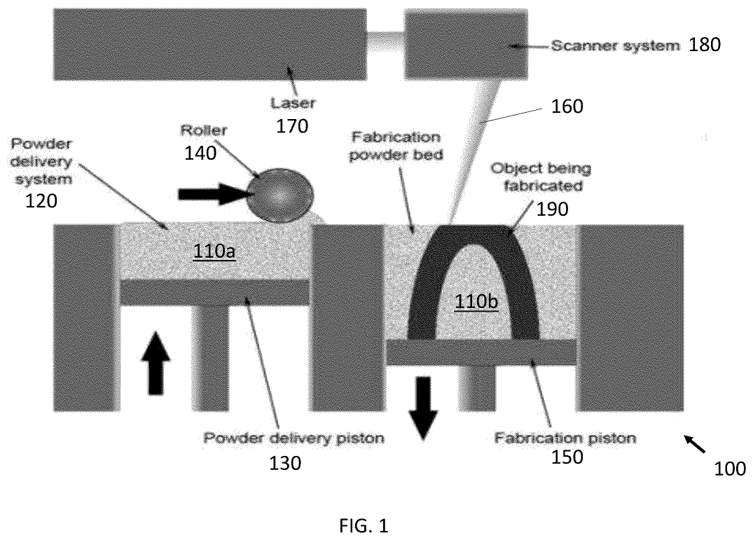

In aspects, the coatings are applied in constant volume processing, such as the constant volume processing hardening processes described herein. In aspects, they are applied via closed or clamped openings of AM article channels (e.g., powder delivery a system 120 and fabrication powder bed shown in FIG. 1). In aspects, the article channels deliver both coating material as well as other additives, such as additional reagent not included in the coating (e.g., to provide the powder environment with ambient reagent). In aspects, the coatings are applied in a modified atmosphere to, for example, enhance coatings (e.g., pressurized or vacuum environments) and/or prevent contamination. In aspects, they are applied in reactive environments, such as in an NH₃ as described in co-pending U.S. Provisional Patent Application No. 63/017,273. In aspects, the coatings include other chemicals to facilitate or carry reagent, e.g., urea with or without HCl associate.

In aspects, coatings are applied at temperatures below the temperature at which the reagent in the coating starts to decompose or change its chemical characteristics. In aspects, the coatings are applied when their reagents are in a molten state. In aspects, they are applied by spray, e.g., atomized spray. In some cases, such as the case of the powder-based coatings described below, coatings are applied electrostatically. In aspects, coatings are applied by fluidized bed. In aspects, they are additionally or alternatively be applied by centrifugal force, and/or spin coating. In aspects, the coatings may be applied to flat or non-flat surfaces, and/or to particular aspects or portions of surfaces. In aspects, they are applied selectively to certain surfaces or certain portions of a surface.

Once applied, in aspects, the coating is dried. The drying may remove the vehicle or other components from the coating. In aspects, the vehicle removal process (e.g., heating) is performed at a temperature below the temperature of decomposition of the reagent. Subsequent to drying and/or a vehicle removal process, in aspects, the component with the dried coating is heated for processing. For example, in aspects, the component is heated to a temperature sufficient to decompose the reagent in the coating to provide carbon and/or nitrogen for a hardening process as described herein and in any document incorporated herein by reference.

In aspects, coating materials facilitate reagent dispersion. Chemical or physical aspects of coatings vary depending on factors such as the specific reagent used, the material to be coated, and the processing (e.g., hardening or heating) to be facilitated by the coating. In aspects, coating materials vary with respect to chemical and physical properties.

In aspects, coating materials are designed, formulated, and/or applied to coat specific portions of a component's surface. In aspects, coatings include solvent mixes containing appropriate stoichiometric or volumetric amounts of reagent to coat particular areas of the component's surface. In aspects, coating properties are tuned to selectively coat portions of the component's surface (e.g., finished valve-product media contacting passages). Several non-limiting examples of types of coatings follow.

### Powder Type Coatings

Coatings may be substantially powder like, comprising other materials (e.g., vehicles or wetting agents) interspersed with reagent powder. Powder coatings may include any of the vehicles, reagents, or additives described herein. The other materials in the coatings may be chemically bonded or complexed with the reagent, or not (e.g., physically mixed with reagent). An exemplary powder type coating comprises polymer and reagent. Exemplary coatings include “a staged” monomer (e.g., melamine) prior to “b stage” compounding with additional thermosetting reactants. The reagent powder may be associated with other compounds (e.g., HCl). Powder coatings may also lack reagents.

The reagent powder may be associated with other compounds (e.g., HCl). A powder coating may be sufficiently mechanically durable to adhere to and/or protect component surfaces for extended time periods (e.g., minutes, hours, or days) between coating and treatment (e.g., hardening and/or heating). Coatings may also include a mixture of powder metal and powder reagent. For example, the coating may include metal catalyst (e.g., 316SS or other alloy metal power) mixed with the reagent. In some cases, including such a metal catalyst with the reagent improves reagent reactivity.

Specific, non-limiting examples of powder type coatings in addition to the above that may be used include polyolefin and polypropylene among others.

### Water Based Coatings

Water based coatings may include reagent. The water itself may act as a vehicle for the reagent. The water may further include other vehicles for the reagent. The water based coating may be of a suspension or emulsion-type water-based solution. Water based coatings may include any of the vehicles, reagents, or additives described herein.

Suitable examples of vehicles include surfactants and polypropylene oxide, polyethylene oxide, and polyvinyl acetate among others. Examples of a suitable vehicle include, but are not limited to, non-ionic surfactants including polyethylene oxide, polypropylene oxide, among others. The chemical identities of vehicle and reagent, as well as the stoichiometric ratio of vehicle to reagent (or other components of the coating), may be individually or simultaneously tailored to coat reagent on the component's surface. This may include tailoring for a particular component surface chemistry or morphology. For example, it may be desired to coat hard to reach certain component surfaces (e.g., inner surfaces and/or surfaces that face obstructions). It may be desired to coat complicated component shapes or surfaces, including select portions of those surfaces. Water based coatings in liquid form may be applied via pressurization and/or flushing through the component, especially when coating component inner surfaces. For example, the pressurizing and/or flushing processes may be especially useful for coating media contacting surfaces in finished valve products. Some water-based coatings may be applied by dip coating the component in the coating liquid.

Once applied, a water-based coating may be air or gas dried. Drying may remove the vehicle in the coating, leaving primarily, essentially, or exclusively reagent. Drying may be accomplished by conventional blowing means, e.g., blow drying with or without heating the gas stream. The gas(es) may include air, inert gases, or other types of gases. Drying may also be accomplished via vacuum to cause outgassing of certain parts of the coating, for example the vehicle. The vacuum treatment may include heating the coating and/or component to temperatures below the decomposition temperature of the coating reagent, e.g., 180 to 200° C. Traps for particular chemical components may assist this process and may be included in the vacuum and or oven system(s). Fungicide and bacteria controls may also be included in the drying process. Outgassing may monitored to a particular stage (e.g., complete outgassing of coating vehicle) via vacuum gage or pressure gauges.

Specific, non-limiting examples of water-based coatings that may be used include coatings based on polyethylene oxide.

### Deposition-Based or Gas-Deposited Coatings

Deposition-based or gas-deposited coatings may include any of the vehicles, reagents, and additives described herein. Reagent material may be applied to the surface of the workpiece by deposition methods including, but not limited to, PVD and CVD processes. The reagent may be carried by a vehicle chemical species and deposited onto the part surface. Additives to the vehicle or the reagent material may modify a coating and process properties including adhesion, wettability, reagent volatilization and decomposition behavior. Such processes may occur at a variety of temperatures and pressures to achieve the desired coating thickness, location specificity, coating morphology, and coating composition.

Coatings may be deposited via gas also simply by settling of the gas constituents on the workpiece. In other words, no particular chemical or mechanical deposition event is required. The coating may simply accumulate on the surface of the workpiece as a film.

### Non-Water Solvent Based Coatings

Various solvents, solvent blends, or other modifiers to tailor rheological properties and enhance processability may also be included in the coatings (powder, liquid, paste, gel, etc.) disclosed herein. Suitable vehicles include solvents. Coatings may also include solvent mixes that can be removed via appropriate process conditions conducing to drying/evaporation while depositing a coating of reagents on the surface. Vehicles can include viscosity and surface-active agents to facilitate the coating application and adhesion/wetting to the surface, as well as the suspension of the reagent in the coating vehicle.

Solvent based coatings can be applied and off-gassed/dried in a similar method. Alcohol and alcohol solvent mixes with appropriate solubility, viscosity and distillation points are examples of suitable solvent mixes. Similar mixtures exist in fluxing operations during printed wiring board and other electronic manufacturing processes. Such processes are typically dried under a nitrogen blanket. Such coatings may or may not contain a vehicle that lends itself to a cohesive dry coating which encapsulates or suspends the chemical reactants. This vehicle upon heating may leave the system into the gas phase, leaving the desired reagent chemicals behind. The temperature of vehicle vaporization may be above the solvent drying temperature, but below the temperature at which the reagent interacts with the metal surface causing activation and/or surface hardening. Drying may also be accomplished by heating the coated workpiece. Vehicles can include viscosity and surface-active agents to facilitate the coating application and adhesion/wetting to the surface, as well as the suspension of the reagent in the coating vehicle.

Solvent mixes containing appropriate stoichiometric or volumetric amounts of reagent may be used to coat some workpieces. They can selectively coat finished valve-product media contacting passages or hardened tooling, for example. This process may have some similarities to flux applications for electronic components.

Examples of solvents include, but are not limited to, organic solvents. Non-limiting specific examples of such organic solvents include toluene, acetone, methylamine, chloroform, acetonitrile, isopropanol, ethanol, dioxane, dimethylsulfoxone, hexane, aniline, glycerol. They also include solvent mixes, of any of the solvents described herein. The solvent mixes can be removed via appropriate process conditions conducing to drying/evaporation while depositing an coating of reagents on the surface.

### Oil Based Coatings

Oil (e.g., mineral oil, finely distilled oil, and/or food-grade oil) may be used to coat component surfaces with reagent. The oil may include a dispersion of reagent with a concentration or volume fraction tailored for specific applications (e.g., as discussed above in the context of water-based coatings). The oil may also include HCl associated or complexed with reagent in stoichiometric ratio or volume fraction tailored for particular applications. Such an HCl/reagent mixture may be used to provide, for example, a room temperature coating.

Oil-based coatings, once applied, may be dried and/or outgassed in a similar manner as water-based coatings described above. The oil-based coatings may include any of the vehicles, reagents, and additives described herein.

For example, a vacuum oven outfitted with a roughing pump and cleanable traps for chemical components may be heated to remove the mineral oil. The heating may be to a temperature that is substantially below the decomposition temperature of the reagent. The heating temperature may be chosen based on the oil properties. For example, if the oil is a mineral oil, the heating temperature may be chosen based on the distillate temperature profile of the mineral oil. The oil may be recycled after removal from the coating. Additional distillation or filtration of the recycled oil can improve its purity. The distillation or filtration may be applied during oil removal or as a separate, standalone process, depending on the level of oil contamination. Oil based coatings may be used in combination with HIP processes.

Specific, non-limiting examples of oil based coatings that may be used, in addition to the above, include finely distilled paraffinic mineral oils, among others.

### Reagents in Machining Oils

The oil-based coatings described above can be applied via machining oils for workpieces. In other words, the oils used to machine workpieces could include one or more of the reagents disclosed herein.

In an exemplary configuration, machining oils coating ferrules in a machine working center include reagents. Finished and machined ferrules leave a machine working center wet with the oil including the reagents. The oil-wet ferrules can then be placed in a furnace. The high temperature of the furnace could evaporate the oils are evaporated leaving a reagent coating on the ferrules. The base oil can be removed aid of vacuum heating to reduce drying times. If vacuum systems are used, the base oil can be recovered and recycled making it more cost effective. If, on the other hand, the oil is not fully evaporated, an oil composition would preferably be chosen that would not interfere with activation and/or hardening reactions. The reagent coating, whether including residual oil or not, could subsequently be used to facilitate activation and/or hardening of the ferrule, as disclosed above.

Both hydrocarbon or emulsion (water based) machining oils can accommodate additives such as the reagents disclosed herein. In fact, such oils typically already contain additives for various purposes, including extending machine tool life, reduce bacterial and fungal blooms, and extending oil life. Reagent, as disclosed herein, can also be added. Hydrocarbon based machine oils can be preferable for more demanding applications, such as those in which the finished machined article is complex.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A method for chemically modifying a surface layer, the method comprising:
placing an article in a nitrogen rich environment;
adding, to the nitrogen rich environment, a compound comprising a guanidine [HNC(NH₂)₂] moiety, the guanidine [HNC(NH₂)₂] moiety being complexed with HCl; and
altering a chemical composition of the surface layer by subjecting the article, in the nitrogen rich environment, to a heating profile, wherein:
the heating profile comprises a single isotherm having a temperature of 550° C. or less and a duration of 30 minutes or less;
the surface layer reacts with decomposition products of the guanidine [HNC(NH₂)₂] moiety during the heating profile; and
upon conclusion of the heating profile, the reaction with the decomposition products of the guanidine [HNC(NH₂)₂] moiety renders the surface layer richer in nitrogen than a core of the article.

2. The method of claim 1, wherein the compound comprising a guanidine moiety [HNC(NH₂)₂] comprises at least one of guanidine HCl, dimethylbiguanide HCl, biguanide HCl, bis(diaminomethylidene) HCl, and carbamimidoylimidodicarbonimidic diamide HCl.

3. The method of claim 1, wherein subjecting the article to a heating profile comprises one or more of carburizing, nitriding, and nitrocarburizing.

4. The method of claim 3, wherein the one or more of carburizing, nitriding, and nitrocarburizing is completed in fewer than 30 minutes.

5. The method of claim 3, wherein the one or more of carburizing, nitriding, and nitrocarburizing comprises exposing the article to at least one of vapors produced by decomposing a reagent, a solid pyrolysis product, and a liquid pyrolysis product.

6. The method of claim 5, wherein the reagent comprises melamine HCl.

7. The method of claim 1, further comprising additively manufacturing the article prior to subjecting the surface layer to the heating profile.

8. The method of claim 1, wherein a corrosion resistance of pores in the surface layer is substantially increased by subjecting the article to the heating profile.

9. The method of claim 1, wherein the treated surface layer has a carbon concentration of 5 to 15 atomic % and a nitrogen concentration of 5 to 15 atomic %.

10. The method of claim 8, wherein the treated surface layer comprises one or more of fine nitride and fine carbide precipitates which augment corrosion resistance.

11. The method of claim 8, wherein at least one of:
the nitrogen in the treated surface layer is present primarily as interstitial nitrogen;
the treated surface layer has a porosity of less than 1%;
the treated surface layer has a porosity of greater than 3%; and
the treated surface layer has a compressive stress of 1 GPa or greater.

12. The method of claim 1, further comprising leaving at least one untreated surface on one of a channel, groove, or cavity of the article.

13. The method of claim 1, further comprising at least one of:
bead blasting; and
polishing before carburizing, nitriding, and nitrocarburizing.

14. The method of claim 1, wherein the subjecting the article to a heating profile further comprises at least one of:
modifying an area of a first surface; and
one or more of carburizing, nitriding, or nitrocarburizing the article to change the hardness or corrosion resistance of at least a portion of the first surface.

15. The method of claim 14, wherein:
the modifying an area comprises applying a chemical that facilitates or enhances the one or more of carburizing, nitriding, or nitrocarburizing of the modified area; and
the one or more of carburizing, nitriding, or nitrocarburizing the article increases the hardness or corrosion resistance of the modified area.

16. The method of claim 14, wherein:
the modifying an area comprises applying a substance that substantially prevents carburizing, nitriding, or nitrocarburizing of the modified area; and
the one or more of carburizing, nitriding, or nitrocarburizing the article increases the hardness or corrosion resistance of at least a portion of the first surface other than the modified area.

17. The method of claim 16, wherein the applied substance is copper.

18. A method for chemically modifying an additively manufactured article, the method comprising:
placing an additively manufactured article in a nitrogen rich environment;
adding, to the nitrogen rich environment, a compound comprising a guanidine [HNC(NH₂)₂] moiety, the guanidine moiety being complexed with HCl; and
chemically modifying corrosion resistance of a surface layer of the article by subjecting the article to a heating profile in the nitrogen rich environment, the heating profile comprising a single isotherm having a temperature of 550° C. or less and a duration of 30 minutes or less,
wherein, upon conclusion of the heating profile, the surface layer is richer in nitrogen than a core of the article.

19. The method of claim 18, wherein the compound comprising a guanidine moiety [HNC(NH₂)₂] comprises at least one of guanidine HCl, dimethylbiguanide HCl, biguanide HCl, bis(diaminomethylidene) HCl, and carbamimidoylimidodicarbonimidic diamide HCl.

20. The method of claim 18, wherein subjecting the article to a heating profile comprises one or more of carburizing, nitriding, and nitrocarburizing.
